(19) United States
(12) Patent Application Publication
(10) Pub. No.: US 2009/0200358 A1
(43) Pub. Date: Aug. 13, 2009

(54) ULTRASOUND WELDING DEVICE

(75) Inventors: Eric Violleau, Cuhon (FR); Patrick Cheppe, Basse Goulaine (FR)

Correspondence Address: OLIFF & BERRIDGE, PLC, P.O. BOX 320850, ALEXANDRIA, VA, 22320-4850, US

(73) Assignee: SONIMAT, LENCLOITRE (FR)

(21) Appl. No.: 12/307,413

(22) PCT Filed: Jul. 24, 2007
(86) PCT No.: PCT/FR2007/051715

§ 371 Date: Jan. 5, 2009

(30) Foreign Application Priority Data
Jul. 25, 2006 (FR) 0653111

(51) Int. Cl. B23K 20/10

(52) U.S. Cl. 228/110.1; 228/1.1

(57) ABSTRACT

The present invention relates to a device for ultrasound welding of at least two overlapping sheets, comprising: at least one sonotrode for emitting ultrasound, at least one reaction part disposed at least partially facing the sonotrode, at least one intermediate wall other than a roller, movable relative to the at least one sonotrode and the reaction part, said intermediate wall at least partially defining a gap in which the sheets to be welded are inserted so as to execute at least one seal weld extending parallel in the direction of movement of the intermediate wall at the gap. At least one of the intermediate wall and the sonotrode has a transverse section comprising at least one relief projecting toward the gap.

The present invention relates to devices for the ultrasonic welding of at least two superposed sheets, for example for the notably sealed closure of articles such as small bags or sachets or the assembly of widths of films.

The term “sheet” must not be understood in a limiting manner and covers various composite or noncomposite substrates capable of being melted locally under the effect of ultrasonic vibrations.

The ultrasonic welding devices comprise, in a conventional manner, a sonotrode and an anvil defining an air gap through which the sheets to be welded are inserted, by means of a pincer driving system for example.

It may be desirable to have a considerable length of air gap, relative to the direction of travel of the sheets, because this makes it possible to increase the time the sheets spend in the air gap or, at comparable power, to increase the speed at which the sheets travel in the air gap and thereby increase the welding rate.

French patent FR 2 784 051 discloses an ultrasonic welding device in which the anvil is fixed and in which the air gap has a particular profile. The end of the sonotrode coming into contact with the sheets to be welded is oriented longitudinally, parallel to the direction of travel of the sheets.

To produce an effective weld, it is necessary to clamp the sheets between the sonotrode and the anvil, which generates friction making it necessary to provide a relatively complex system of driving the sachets or small bags through the air gap. This driving system is also likely to constitute a brake to obtaining high welding rates, and does not make it possible to weld a product that does not have a nonmeltable layer, such as a product made of aluminum for example.

British patent GB 952 581 discloses an ultrasonic welding device in which the anvil comprises a roller. Such a device, although it reduces friction, does not make it possible to have a considerable length of air gap, without increasing the diameter of the roller and therefore the size and cost of the device.

U.S. Pat. No. 5,830,311 discloses an ultrasonic welding device comprising a plurality of stops supported by a conveyor belt traveling in a closed loop. Each of the stops is placed, when the conveyor belt travels on the path of the ultrasounds, between the sonotrode and a reaction roller.

Such a device, which does not make it possible to obtain a seal, is suitable for welding two sheets while forming folds, thanks to the stops. The weld lines therefore extend longitudinally between the folds, along the sides of the stops, perpendicular to the direction of movement of the conveyor belt.

Patent application FR 2 225 247 A1 discloses an ultrasonic welding method comprising one or more metal strips, not suitable for welding a sealed-packaging product.

The object of the invention is to further enhance the ultrasonic welding devices in order notably to benefit from a device capable of operating at relatively high rates and which can be relatively compact and low-cost, while providing a weld quality tending to guarantee the seal.

The subject of the invention therefore, according to one of its aspects, is a device for the ultrasonic welding of at least two superposed sheets, notably in order to produce a sealed weld, comprising:
at least one sonotrode for emitting ultrasounds,
at least one reaction piece placed at least partially facing the sonotrode,
at least one intermediate wall other than a roller, that can be moved relative to at least one of the sonotrode and the reaction piece, this intermediate wall delimiting at least partially an air gap in which the sheets to be welded are inserted so as to make at least one weld extending parallel to the direction of movement of the intermediate wall at the air gap.

In one exemplary embodiment of the invention, at least one of the intermediate wall and the sonotrode has a cross section, relative to the direction of movement of the sheets, having at least one protruding raised element coming into contact with at least one sheet. This protruding raised element has for example a triangular or sawtooth profile.

The triangular profile is for example produced on the sonotrode and may extend over a narrower area than the intermediate wall.

The sawtooth profile is for example made on the intermediate wall, the number of teeth being for example between 2 and 6, over a narrower width than that of the face facing the sonotrode coming into contact with the sheet to be welded.

When the raised element is made on the sonotrode, the intermediate wall may have a flat face opposite it.

When the raised element is made on the intermediate wall, the sonotrode may have a flat face opposite it. A nonrectangular cross section of the intermediate wall may be advantageous in that it may make it possible to produce the sonotrode with a flat end face, therefore to simplify its manufacture while making it possible to control the creep of the sheet material.

The invention may increase the possibilities of driving the articles to be welded, by using, for example, driving systems other than with pincers, for example with cups.

In one exemplary embodiment of the invention, the intermediate wall can be moved in contact with the reaction piece. As a variant, the intermediate wall can be moved in contact with the sonotrode and in a further variant, the ultrasonic welding device comprises a first intermediate wall that can be moved in contact with the reaction piece and a second intermediate wall that can be moved in contact with the sonotrode, the air gap being defined between these first and second intermediate walls.

The or each intermediate wall may be defined by a belt traveling in a closed loop, this belt being for example engaged on end wheels and being able to be made in one piece, of a metal or a composite, for example. The composite may be formed of several layers adhering to one another. The metal may have received a treatment, notably a surface treatment, so as to harden it, for example a nitriding.

The reaction piece may comprise, notably when the intermediate wall travels to make contact with it, a coating designed to make the intermediate wall slide more easily, for example a coating of a fluorinated polymer, notably of polytetrafluoroethylene.

The intermediate wall may travel in a continuous manner or intermittently, being for example synchronized with the travel of articles to be welded, for example the sachets or small bags.

The sonotrode may have a generally tapered shape, with one end extending longitudinally parallel to the direction of travel of the sheets to be welded.

The intermediate wall, notably the belt, may have a width exceeding that of the end of the sonotrode and/or that of the reaction piece. This may make it possible to use an overlapping portion of the intermediate wall to perform another function, for example a marking, an etching, a depression or a perforation.

The ultrasonic welding device may comprise a device for adjusting the tension of the belt, in order for example to keep the latter constant.

A further subject of the invention, according to another of its aspects, is a device for the ultrasonic welding of at least two superposed sheets, comprising:
at least one sonotrode for emitting ultrasounds,
at least one reaction piece placed at least partially facing the sonotrode,
at least one belt that can be moved relative to at least one of the sonotrode and the reaction piece, this belt delimiting at least partially an air gap into which the sheets to be welded are inserted,
   the belt being able to move at a speed greater than the speed of movement of the sheets.

A further subject of the invention, according to another of its aspects, is an ultrasonic welding method, comprising the step consisting in causing to travel at least two sheets to be assembled in a sealed manner in contact with an intermediate wall placed between a sonotrode and a reaction piece and moving in contact with one of the sonotrode and the reaction piece, other than with a purely rotary movement, so as to produce a weld line extending substantially parallel to the direction of movement of the intermediate wall. The latter may move at a higher speed, for example of the order of 3 to 10% higher, thereby compensating for the lengthening of the material caused by the melting and the reduction in thickness of the material.

The invention will be better understood on reading the following detailed description of nonlimiting exemplary embodiments of the latter and on examining the appended drawing in which:

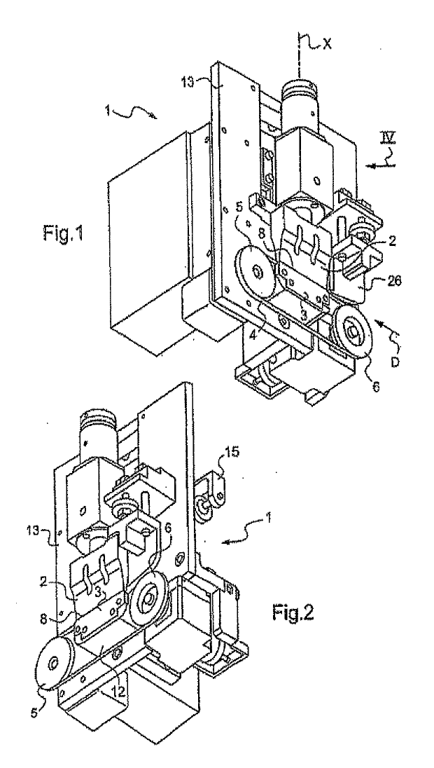

FIG. 1 is a schematic view in perspective of an example of an ultrasonic welding device produced according to the invention,

FIG. 2 is a view similar to FIG. 1 from another viewing angle,

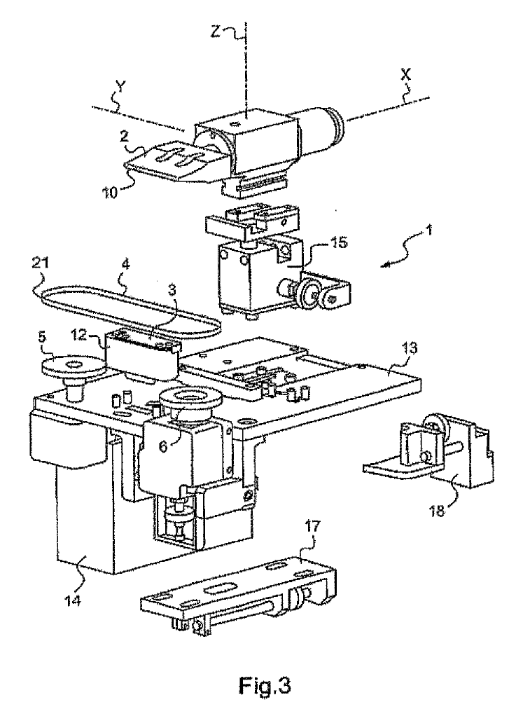

FIG. 3 is an exploded perspective of the device of FIGS. 1 and 2,

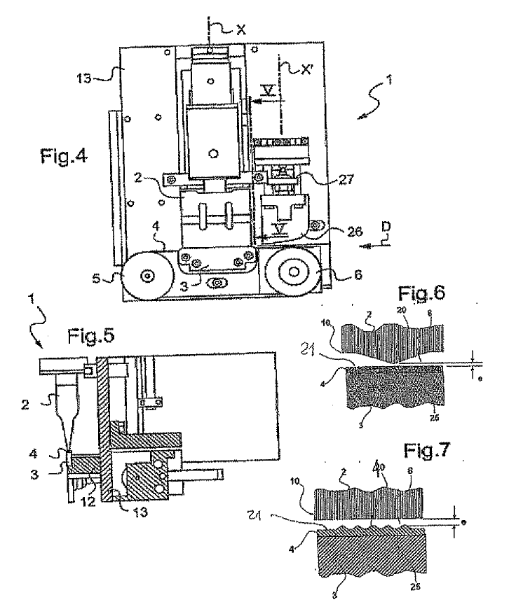

FIG. 4 is a front view, in the direction of the arrow IV of FIG. 1,

FIG. 5 is a section along V-v of FIG. 4,

FIG. 6 is a cross section at the air gap,

FIG. 7 is a view similar to FIG. 6 according to a variant embodiment of the invention.

The ultrasonic welding device 1 shown in FIGS. 1 to 6 comprises a sonotrode 2 with an axis X placed facing a reaction piece 3.

The frequency of excitation of the sonotrode is for example between 20 and 40 kHz, the latter being able to be chosen notably according to the nature of the sheets to be welded.

An intermediate wall 4 forming an anvil, having the shape of a belt rotating on two wheels 5 and 6, travels between the sonotrode 2 and the reaction piece 3 in order to define, with the sonotrode 2, as illustrated in FIG. 6, an air gap 8 with a thickness e through which may be inserted, in the direction of travel D of the belt 4, at least two sheets to be welded in a sealed manner. For example they may be two sheets of a sachet or of a small bag to be closed.

The thickness e of the air gap may be chosen according to the weld to be formed, preferably always being less in the welding zone than the total thicknesses of at least two sheets to be assembled.

In the example of FIG. 6, the face of the sonotrode facing the sheets to be welded has a triangular profile with an angle at the vertex for example of between 90 and 170°.

The width of the triangular profile is for example between 0.5 and 10 mm.

In the example considered, the sonotrode 2 has one end 10 which is elongated along a longitudinal axis Y perpendicular to the axis X and substantially parallel to the direction D of travel of the belt 4 at the air gap 8.

The ridge 20 of the vertex extends for example parallel to the direction of travel of the sheets over a distance of between 50 and 250 mm.

The reaction piece 3 is fixed to a support 12 connecting it rigidly to a frame 13. The latter may support a drive unit 14 rotating at least one of the wheels 5 and 6, for example with a slightly higher speed which may be of the order of 3 to 10% higher than the speed of travel of the sheets in the air gap 8 in order to reduce the risk of forming folds between these sheets in the welding zone and to compensate for the lengthening of the material due to the melting and the reduction in thickness.

The driving of the belt 4 may be slaved, as appropriate, to the speed of travel of the articles, with a speed differential.

Such a slaving has the advantage of being able to accompany the passage of the sheets whatever their movement, for example with a constant speed, varying in a sinusoidal or other manner or varying intermittently.

The sonotrode 2 may be mounted on the frame 13 by means of a first adjustment mechanism 15 which makes it possible to adjust its orientation about an axis of rotation Z perpendicular to the axes X and Y, in order for example to make it easier to access the articles in the air gap. The sonotrode 2 may also be mounted so as to be adjustable in translation along its axis X relative to the frame 13 by means of a second adjustment mechanism 17 in order to adjust the value of the air gap.

If necessary, the sonotrode 2 may be moved by a drive system making it possible to modify the value of the air gap in response to a control action, in order for example to regulate at least one operating parameter.

The ultrasonic welding device 1 may for example be used with the horizontal axis Y and the vertical axes of rotation of the wheels 5 and 6. Naturally, the invention is not limited to a particular orientation of the welding device 1, the latter being able to be chosen according to the nature of the articles to be welded and of the environment in which the device is placed.

In the example considered, the belt 4 is metallic, being made with a smooth outer face 21, notably at the join closing it on itself, so as not to introduce a variation in the value of the air gap when it travels between the sonotrode 2 and the reaction piece 3.

In the example of FIG. 6, the belt 4 has a rectangular cross section.

However, the invention is not limited to a particular intermediate wall and the belt 4 may notably have a protruding raised element, as illustrated in FIG. 7. As appropriate, the outer surface of the belt 4 may be etched or eroded, in order for example to produce a pattern on the weld zone.

In this example, the face 21 of the belt 4 turned toward the air gap has a sawtooth profile with for example five teeth 40.

The face facing the end of the sonotrode may be flat.

The height of the teeth is for example between 0.05 and 2 mm and their spacing, measured between the points of two consecutive teeth, is for example between 0.2 and 10 mm.

The belt 4 is for example made of a steel but more generally its material, its dimensions, its shape and its surface state may vary depending on the weld to be produced.

The belt 4 advantageously has a relatively small thickness, for example of between 0.1 and 6 mm, better between 0.1 and 4 mm, still better between 0.1 and 2 mm, in order to have sufficient flexibility to circulate between the wheels 5 and 6.

The belt 4 may have various other shapes in section, notably nonrectangular shapes. A nonrectangular shape, for example circular or triangular, may make it possible to produce the sonotrode with a flat face, the creep of the material then being provided by the geometry of the belt. This may simplify the manufacture of the sonotrode and make it possible to ensure the function of creep that is favorable to obtaining a sealed weld.

The tension of the belt in the example considered is between 0.8 N and 50 N, this tension being able to depend for example on the type of belt, its material, the tread diameter and the friction applied to the latter.

The reaction piece 3 is preferably made of a very hard material, for example a nitrided steel or else various alloys, as a variant.

Advantageously, the reaction piece 3 receives on its face 25 in contact with the belt 4 a surface treatment designed to reduce the friction with the belt 4, for example a fluorinated polymer coating, particularly polytetrafluoroethylene.

The welding device 1 may comprise a sensor, not shown, detecting a break in the belt 4 in order, in this case, to interrupt the operation of the device.

The electric excitation power of the sonotrode may be adjustable and slaved to at least one operating parameter, as appropriate, in order to maintain the quality of the weld made.

The invention is not limited to the examples described and the particular features of embodiment above may be combined within variants not illustrated.

The shape of the sonotrode 2 may be chosen according to the articles to be welded and the invention is not limited to the shape illustrated.

The intermediate wall may come to face more than one sonotrode and one reaction piece, as appropriate.

A means for heating the intermediate wall, by eddy currents, infrared or Joule effect radiation may be provided as appropriate.

The intermediate wall may also be made in the form of a portion of an articulated strip, a single plate or a plate of an assembly of plates placed end to end.

The expression “comprising a” must be understood as being synonymous with “comprising at least one” unless the contrary is specified.

1. A device for the ultrasonic welding of at least two superposed sheets, comprising:
at least one sonotrode for emitting ultrasounds, at least one reaction piece placed at least partially facing the sonotrode,
at least one intermediate wall other than a roller, movable relative to at least one of the sonotrode and the reaction piece, this intermediate wall delimiting at least partially an air gap in which at least two sheets to be welded are inserted so as to make at least one sealed weld extending parallel to a direction of movement of the intermediate wall at the air gap,
at least one of the intermediate wall and the sonotrode having a cross section, relative to the direction of movement of the sheets, having at least one raised element protruding toward the air gap, coming into contact with at least one sheet.

2. A device for the ultrasonic welding of at least two superposed sheets, comprising:
at least one sonotrode for emitting ultrasounds,
at least one reaction piece placed at least partially facing the sonotrode,
at least one intermediate wall other than a roller, movable relative to at least one of the sonotrode and the reaction piece, this intermediate wall delimiting at least partially an air gap in which the sheets to be welded are inserted so as to make at least one sealed weld extending parallel to the direction of movement of the intermediate wall at the air gap,
the intermediate wall being moved at a speed greater than a speed of movement of the sheets to be welded in the air gap.

3. The device as claimed in claim 1, the intermediate wall comprising at least one raised element protruding toward the air gap.

4. The device as claimed in claim 1, the sonotrode comprising at least one raised element protruding toward the air gap.

5. The device as claimed in claim 1, the intermediate wall (*being defined by a belt.

6. The device as claimed in claim 5, the belt having a nonrectangular cross section.

7. The device as claimed in claim 5, the belt being made in one piece of metal or of a composite.

8. The device as claimed in claim 1, the reaction piece comprising, while the intermediate wall travels to make contact with it, a coating configured to make the intermediate wall slide more easily.

9. The device as claimed in claim 8, the reaction piece comprising a coating of a fluorinated polymer.

10. The device as claimed in claim 1, the sonotrode having a generally tapered shape, with one end extending longitudinally substantially parallel to the direction of travel of the sheets to be welded.

11. The device as claimed in claim 10, the intermediate wall having a width exceeding that of the end of the sonotrode.

12. The device as claimed in claim 1, the intermediate wall being moved at a speed greater than the speed of movement of the sheets to be welded in the air gap.

13. The device as claimed in claim 1, the traveling of the intermediate wall being continuous.

14. The device as claimed in claim 1, the traveling of the intermediate wall being slaved to the traveling of the sheets.

15. An ultrasonic welding method, comprising the step of causing to travel at least two sheets to be assembled in contact with an intermediate wall placed between a sonotrode and a reaction piece, the intermediate wall moving in contact with one of the sonotrode and the reaction piece other than with a purely rotary movement, so as to produce a sealed weld line extending substantially parallel to a direction of movement; at least one of the intermediate wall and the sonotrode having a cross section, with respect to the direction of movement of the sheets, comprising at least one raised protruding element coming into contact with at least one sheet.

16. An ultrasonic welding method comprising the step of causing to travel at least two sheets to be assembled in contact with an intermediate wall placed between a sonotrode and a reaction piece, the intermediate wall moving in contact with one of the sonotrode and the reaction piece other than with a purely rotary movement, so as to produce a sealed weld line extending substantially parallel to a direction of movement, wherein the intermediate wall is moved at a speed greater than the speed of movement of the sheets to be welded in the air gap.
